(19) United States
(12) Patent Application Publication
(10) Pub. No.: US 2026/0320869 A1
(43) Pub. Date: Oct. 15, 2026

(54) INFORMATION PROCESSING APPARATUS, INFORMATION PROCESSING SYSTEM, AND INFORMATION PROCESSING METHOD

(71) Applicants: Shuhei WATANABE, Chiba (JP); Mizuki SHINKAWA, Kanagawa (JP); Yuki ABE, Kanagawa (JP); Ryoichi TERANISHI, Kanagawa (JP)

(72) Inventors: Shuhei WATANABE, Chiba (JP); Mizuki SHINKAWA, Kanagawa (JP); Yuki ABE, Kanagawa (JP); Ryoichi TERANISHI, Kanagawa (JP)

(21) Appl. No.: 19/630,512

(22) Filed: Mar. 27, 2026

(30) Foreign Application Priority Data
Apr. 9, 2025 (JP) 2025-064389

(51) Int. Cl. G06T 11/60; G06F 3/01; G06V 40/16; G10L 25/63

(52) U.S. Cl. CPC G06T 11/60; G06F 3/012; G06V 40/174; G10L 25/63; G06F 2203/011

(57) ABSTRACT

An information processing apparatus includes circuitry that: acquires unique data indicating unique information based on behavior of each of a plurality of participants in a gathering, the plurality of participants participating in the gathering; generates, for each of the plurality of participants, a corresponding image associated with the unique data, based on the unique data and a machine learning model trained using training data, the training data including unique data indicating the unique information and an image; and analyzes an emotion of each of the plurality of participants based on the unique data.

### CROSS-REFERENCE TO RELATED APPLICATIONS

This patent application is based on and claims priority pursuant to 35 U.S.C. § 119(a) to Japanese Patent Application No. 2025-064389, filed on Apr. 9, 2025, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

In a gathering where a plurality of persons participate in interaction, such as a meeting, for example, graphic recording may be used to visualize the discussion held by the participants, thereby enhancing a shared understanding of the gathering.

A communication system has been proposed that presents appropriate visual information related to information communication in accordance with the progress of information communication by speech, text input, or the like. The communication system includes a language information input unit that receives an input of language information, a recognition unit that recognizes the input language information, and an image display unit that displays, on a display unit that displays an image, an image corresponding to the input language information, based on a recognition result obtained by the recognition unit. The communication system searches for and outputs an illustration or an image corresponding to language information recognized from speech or text.

### SUMMARY

The present disclosure described herein provides an information processing apparatus including circuitry. The circuitry acquires unique data indicating unique information based on behavior of each of a plurality of participants in a gathering, the plurality of participants participating in the gathering. The circuitry generates, for each of the plurality of participants, a corresponding image associated with the unique data, based on the unique data and a machine learning model trained using training data, the training data including unique data indicating the unique information and an image. The circuitry analyzes an emotion of each of the plurality of participants based on the unique data.

The present disclosure described herein provides an information processing system including circuitry. The circuitry acquires unique data indicating unique information based on behavior of each of a plurality of participants in a gathering, the plurality of participants participating in the gathering. The circuitry generates, for each of the plurality of participants, a corresponding image associated with the unique data, based on the unique data and a machine learning model trained using training data, the training data including unique data indicating the unique information and an image. The circuitry analyzes an emotion of each of the plurality of participants based on the unique data.

The present disclosure described herein provides an information processing method including acquiring unique data indicating unique information based on behavior of each of a plurality of participants in a gathering, the plurality of participants participating in the gathering; generating, for each of the plurality of participants, a corresponding image associated with the unique data, based on the unique data and a machine learning model trained using training data, the training data including unique data indicating the unique information and an image; and analyzing an emotion of each of the plurality of participants based on the unique data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are diagrams illustrating example configurations of an information processing system according to a first embodiment;

FIG. 2 is a diagram illustrating an example hardware configuration of a terminal apparatus according to the first embodiment;

FIG. 3 is a diagram illustrating an example functional configuration of the information processing system according to the first embodiment;

FIG. 4 is a sequence diagram illustrating an example of a processing procedure executed by the information processing system according to the first embodiment;

FIG. 5 is a diagram illustrating an example of screens displayed in the first embodiment;

FIG. 6 is a diagram illustrating a first specific example of a screen;

FIG. 7 is a diagram illustrating a second specific example of a screen;

FIG. 8 is a diagram illustrating a third specific example of a screen;

FIG. 9 is a flowchart illustrating an example of a processing procedure executed by an information processing system according to a second embodiment;

FIG. 10 is a diagram illustrating an example of a collaborative conference system screen;

FIG. 11 is a diagram illustrating a first display example of a collaborative conference system screen including corresponding images;

FIG. 12 is a diagram illustrating a second display example of a collaborative conference system screen including corresponding images;

FIG. 13 is a diagram illustrating a display example of minutes data;

FIG. 14 is a diagram illustrating an example functional configuration of an information processing system according to a third embodiment;

FIG. 15 is a diagram illustrating an example hardware configuration of a terminal apparatus according to a fourth embodiment;

FIG. 16 is a diagram illustrating an example functional configuration of an information processing system according to the fourth embodiment;

FIG. 17 is a diagram illustrating an example functional configuration of an information processing system according to a fifth embodiment;

FIG. 18 is a diagram illustrating a display example of corresponding images according to the fifth embodiment;

FIG. 19 is a diagram illustrating a second display example of corresponding images according to the fifth embodiment; and

FIG. 20 is a diagram illustrating an example of visual representations of the probabilities of emotions in association with respective corresponding images.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

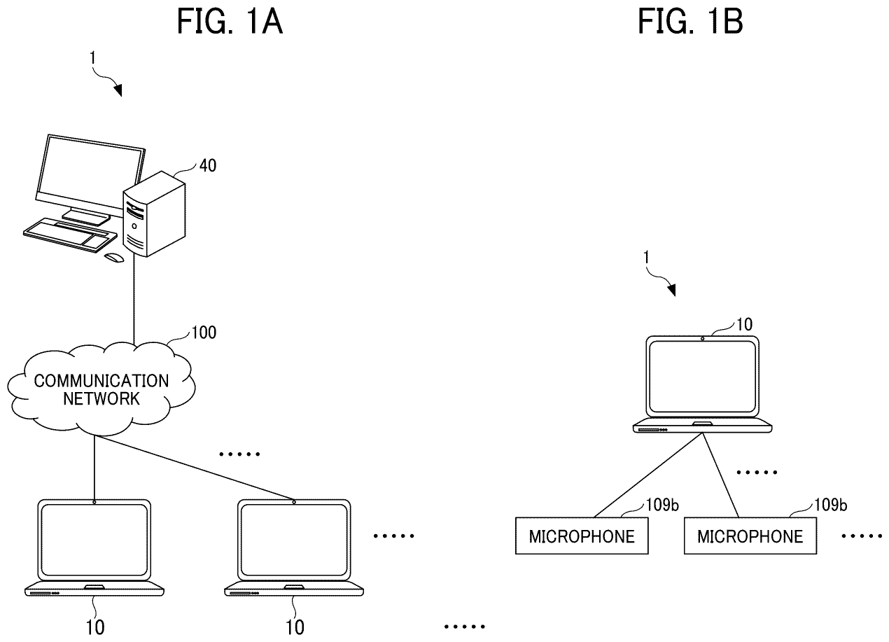

In some embodiments, a meeting is an example of a gathering. The present disclosure is also applicable to gatherings other than meetings, such as training sessions and classes. FIGS. 1A and 1B are diagrams illustrating example configurations of an information processing system 1 according to a first embodiment. FIGS. 1A and 1B illustrate two example configurations of the information processing system 1.

The configuration illustrated in FIG. 1A supports an online meeting such as a web meeting or a video meeting. In FIG. 1A, terminal apparatuses 10 are arranged for a respective one of the participants of the meeting. The terminal apparatuses 10 are connected to a server apparatus 40 via a communication network 100 such as the Internet.

The server apparatus 40 includes one or more computers that generate an image based on audio data captured by each of the terminal apparatuses 10.

The configuration illustrated in FIG. 1B supports a meeting conducted face-to-face. In FIG. 1B, one terminal apparatus 10 is arranged for a plurality of participants participating in the meeting. A microphone 109b is connected to or incorporated in the terminal apparatus 10. One or more microphones 109b may be arranged. When a plurality of microphones 109b are arranged, a highly directional microphone may be provided for each participant such that a participant who has made an utterance can be identified based on which of the microphones 109b has captured the speech of the participant. In the configuration illustrated in FIG. 1B, the terminal apparatus 10 generates an image based on audio data captured by the microphone 109b.

In the following description, the configuration illustrated in FIG. 1A may be referred to as “configuration A”, and the configuration illustrated in FIG. 1B may be referred to as “configuration B”.

As used herein, the term “meeting” refers to a discussion such as a conversation or interaction involving two or more persons, and a format thereof is not limited to any specific one.

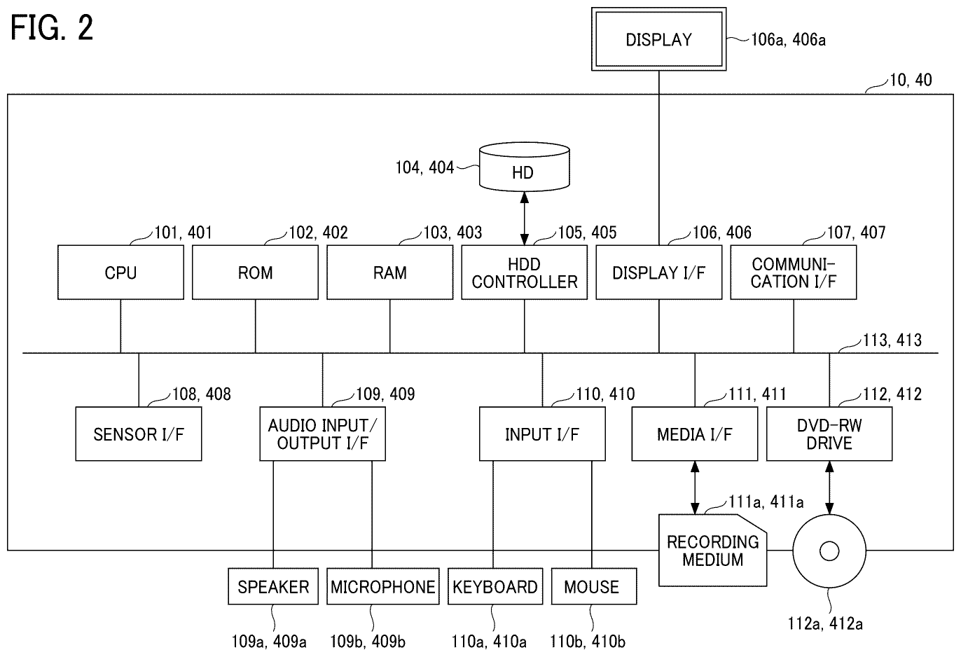

FIG. 2 is a diagram illustrating an example hardware configuration of the terminal apparatus 10 according to the first embodiment. FIG. 2 illustrates the hardware configuration of the terminal apparatus 10. The hardware configuration of the server apparatus 40 is similar to that of the terminal apparatus 10, and a description thereof is thus omitted. In FIG. 2, components of the terminal apparatus 10 are designated by reference numerals in the 100 series, and components of the server apparatus 40 are designated by reference numerals in the 400 series.

The terminal apparatus 10 is implemented by a computer. As illustrated in FIG. 2, the terminal apparatus 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls the overall operation of the terminal apparatus 10. The ROM 102 stores a program used for booting the CPU 101, such as an initial program loader (IPL). The RAM 103 is used as a work area for the CPU 101.

The HD 104 stores various data such as a program. The HDD controller 105 controls reading and writing of various data from and to the HD 104 under the control of the CPU 101.

The display I/F 106 is a circuit that controls a display 106a to display an image. The display 106a is a type of display unit such as a liquid crystal display or an organic electroluminescent (EL) display that displays various types of information such as a cursor, a menu, a window, characters, or an image. The communication I/F 107 is an interface used for communication with another apparatus.

The communication I/F 107 is, for example, a network interface card (NIC) in compliance with Transmission Control Protocol/Internet Protocol (TCP/IP).

The terminal apparatus 10 further includes a sensor I/F 108, an audio input/output I/F 109, an input I/F 110, a media I/F 111, and a digital versatile disc rewritable (DVD-RW) drive 112.

The sensor I/F 108 is an interface that receives detection information of various sensors. The audio input/output I/F 109 is a circuit that processes input of an audio signal from a microphone 109b and output of an audio signal to a speaker 109a under the control of the CPU 101. The input I/F 110 is an interface for connecting a predetermined input device to the terminal apparatus 10.

A keyboard 110a is a type of input device including a plurality of keys for inputting, for example, characters, numerical values, or various instructions. A mouse 110b is a type of input device for selecting or executing various instructions, selecting a target for processing, moving a cursor being displayed, or performing an operation on a display screen.

The media I/F 111 controls reading and writing (storing) of data from and to a recording medium 111a such as flash memory. The DVD-RW drive 112 controls reading and writing of various data from and to a DVD-RW 112a, which is an example of a removable recording medium. The removable recording medium is not limited to a DVD-RW and may be, for example, a digital versatile disc recordable (DVD-R). In place of the DVD-RW drive 112, a Blu-ray drive that controls reading and writing of various data from and to a Blu-ray Disc® may be used.

The terminal apparatus 10 further includes a bus line 113. Examples of the bus line 113 include an address bus and a data bus. The bus line 113 electrically connects the components of the terminal apparatus 10, such as the CPU 101, to one another.

The programs described above may be stored in recording media such as an HD and a compact disc read-only memory (CD-ROM), and the recording media may be distributed domestically or internationally as program products. For example, the terminal apparatus 10 executes a program according to an embodiment to implement an information processing method according to an embodiment.

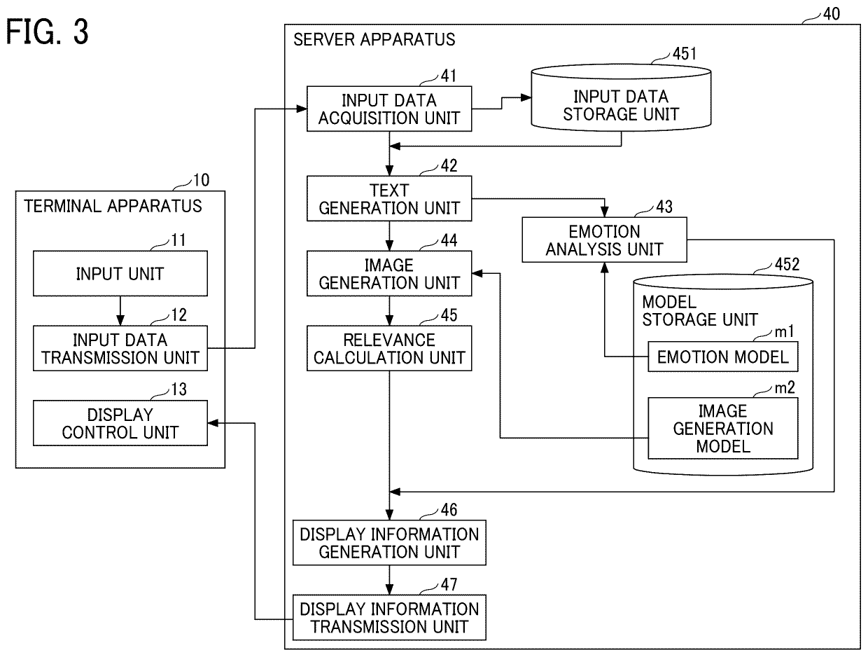

FIG. 3 is a diagram illustrating an example functional configuration of the information processing system 1 according to the first embodiment. In FIG. 3, the terminal apparatus 10 includes an input unit 11, an input data transmission unit 12, and a display control unit 13. Each unit is implemented by processing executed by the CPU 101 in accordance with one or more programs installed in the terminal apparatus 10.

The input unit 11 receives input from a user of the terminal apparatus 10. The user may be a participant of a meeting. For example, the input unit 11 receives an agenda (or topic) of the meeting, the number of participants, or other information (hereinafter referred to as “meeting information”), and receives input of audio data of utterances made by participants of the meeting. The audio data is captured by the microphone 109b during the meeting. The input unit 11 may also, for example, receive input of an image (hereinafter referred to as an “input image”) related to the agenda of the meeting from one or more participants of the meeting.

The input data transmission unit 12 transmits the meeting information or audio data received by the input unit 11 to the server apparatus 40.

The display control unit 13 controls display of a screen or the like based on display information transmitted from the server apparatus 40.

The server apparatus 40 includes an input data acquisition unit 41, a text generation unit 42, an emotion analysis unit 43, an image generation unit 44, a relevance calculation unit 45, a display information generation unit 46, and a display information transmission unit 47. Each unit is implemented by processing executed by the CPU 401 in accordance with one or more programs installed in the server apparatus 40. The server apparatus 40 further includes an input data storage unit 451 and a model storage unit 452. Each storage unit is implementable using, for example, the HD 404 or a storage device connectable to the server apparatus 40 via a network.

The input data acquisition unit 41 acquires (receives) meeting information or audio data transmitted from the input data transmission unit 12, and stores the acquired meeting information or audio data in the input data storage unit 451. As illustrated in FIG. 3, in a case where the server apparatus 40 includes the input data acquisition unit 41, the input data acquisition unit 41 has a receiving function. In the configuration B, in contrast, that is, in a case where the terminal apparatus 10 includes the input data acquisition unit 41, the input data acquisition unit 41 has an input interface function.

The text generation unit 42 generates, for each participant, text data from the audio data acquired by the input data acquisition unit 41. In other words, the text generation unit 42 generates text data indicating utterance content of each meeting participant from the audio data acquired by the input data acquisition unit 41.

The emotion analysis unit 43 analyzes an emotion of each participant, based on text data (an example of unique data) generated by the text generation unit 42 for the participant and indicating the content of an utterance made by the participant and an emotion model m1 stored in the model storage unit 452. The emotion analysis unit 43 generates emotion data. The emotion data is data indicating, for example, for each type of emotion, the probability of the emotion. Such types of emotions include anger, disgust, anxiety, calmness, sadness, and joy.

The emotion model m1 is a machine learning model that generates emotion data from unique data (text data) indicating unique information of each participant of the meeting. The emotion model m1 is trained using training data including text data indicating utterance content and an emotion, for example. The training data includes, for example, training text data as input and a ground-truth emotion for output. The emotion model m1 is trained such that, for example, emotion data generated by the emotion model m1 when text data included in the training data is input maximizes the probability of a ground-truth emotion included in the training data. The emotion model m1 may be a machine learning model that generates emotion data using, as input, physical features such as “voice intonation” and “voice volume” extractable from the audio data acquired by the input data acquisition unit 41. In this case, the training data is a set of the features and a ground-truth emotion. The emotion analysis unit 43 may extract physical features such as “voice intonation” and “voice volume” from the audio data acquired by the input data acquisition unit 41, and generate emotion data based on the features and the emotion model m1.

The image generation unit 44 generates, for each participant, an image corresponding to text data generated by the text generation unit 42 for the participant, based on the text data and an image generation model m2 stored in the model storage unit 452. The image may be referred to as a “corresponding image” in the following description. Specifically, the image generation unit 44 inputs, for each participant, text data related to the participant to the image generation model m2, and acquires, as a corresponding image, an image generated by the image generation model m2 based on the text data.

The text indicating utterance content of each meeting participant is an example of unique information based on the behavior of each participant in a meeting (or gathering). The text data indicating utterance content of a meeting participant is an example of unique data indicating unique information of each meeting participant.

The unique information of each meeting participant may include, in addition to or in place of text indicating utterance content of the meeting participant, at least one of characters input by the meeting participant, operations performed by the meeting participant, captured image information of an image of the meeting participant captured by an image capturing device, and biometric information of the meeting participant detected by a biometric information detector.

The image generation model m2 is a machine learning model (generative artificial intelligence (AI)) that generates an image based on text data, as an example of a machine learning model (generative AI) that generates an image based on unique data indicating respective unique information of meeting participants. The image generation model m2 is trained using, for example, training data including text data and images. The training data includes, for example, training text data as input and a ground-truth image for output. The image generation model m2 may be trained such that, for example, an image generated by the image generation model m2 when text data included in the training data is input approaches a ground-truth image included in the training data. The image generation model m2 may be a model available for commercial use such as a Stable Diffusion model or a DALL-E model, or a model developed independently.

The image generation unit 44 also generates, based on respective text data of a plurality of participants and the image generation model m2, an integrated corresponding image corresponding to a set of the respective text data. Specifically, the image generation unit 44 inputs the set of the respective text data to the image generation model m2, and acquires, as an integrated corresponding image, an image generated by the image generation model m2 based on the set of the respective text data. That is, a corresponding image is generated for each participant, whereas an integrated corresponding image is generated for all the participants.

When an input image is input, that is, when an image input in relation to the meeting is input, the image generation unit 44 may generate, for each participant, a corresponding image based on text data for the participant, the input image, and the image generation model m2, and may also generate an integrated corresponding image corresponding to a set of respective text data of a plurality of participants and the input image. In this case, the image generation unit 44 inputs, for each participant, text data related to the participant and the input image to the image generation model m2, and acquires, as a corresponding image, an image generated by the image generation model m2 based on the text data and the input image. Further, the image generation unit 44 inputs the set of the respective text data to the image generation model m2, and acquires, as an integrated corresponding image, an image generated by the image generation model m2 based on the set. In this case, the corresponding images or the integrated corresponding image may be, for example, an image obtained by changing the input image in accordance with the content of utterances made by the participants.

The relevance calculation unit 45 calculates, for each corresponding image generated by the image generation unit 44, relevance to another image. Relevance is a measure of how pertinent something is. “Another image” for a certain corresponding image refers to, for example, another corresponding image. In this case, relevance between corresponding images is calculated. “Another image” may be an integrated corresponding image. In this case, relevance between each corresponding image and the integrated corresponding image is calculated. “Another image” may also be any other image such as an input image or an image generated in advance based on predetermined text data.

The display information generation unit 46 generates display information for displaying each corresponding image (e.g., display information of a screen including corresponding images). The display information is for displaying emotion data of each participant in association with a respective one of the corresponding images. At this time, when a correspondence relationship between each participant and a corresponding image can be identified, the display information generation unit 46 may generate display information for displaying participant identification information for identifying the participant, the corresponding image, and emotion data of the participant in association with each other. A certain corresponding image is associated with emotion data by, for example, processing the content of the corresponding image based on the emotion data. The processing refers to, for example, blurring the image or correcting colors of the image. The display information generation unit 46 may also generate the display information such that the relevance is displayed in association with the participant identification information and the corresponding image.

The display information transmission unit 47 transmits the display information generated by the display information generation unit 46 to the terminal apparatus 10.

When the information processing system 1 has the configuration B, the components of the server apparatus 40 illustrated in FIG. 3 are included in the terminal apparatus 10.

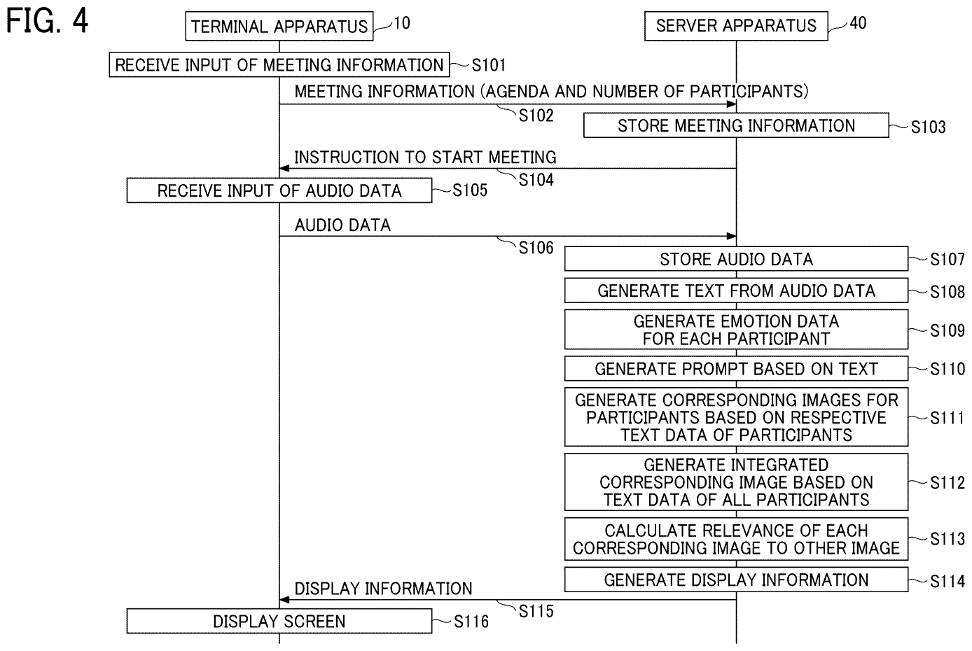

A processing procedure executed by the information processing system 1 is described below. FIG. 4 is a sequence diagram illustrating an example of a processing procedure executed by the information processing system 1 according to the first embodiment. FIG. 4 illustrates an example of a processing procedure in a case where the information processing system 1 has the configuration A. In a case where the information processing system 1 has the configuration B, the terminal apparatus 10 also executes the processing procedure of the server apparatus 40.

In step S101, the terminal apparatus 10 receives, via a displayed screen, input of meeting information from any one (e.g., an organizer) of the meeting participants. The meeting information includes, for example, an agenda and the number of participants.

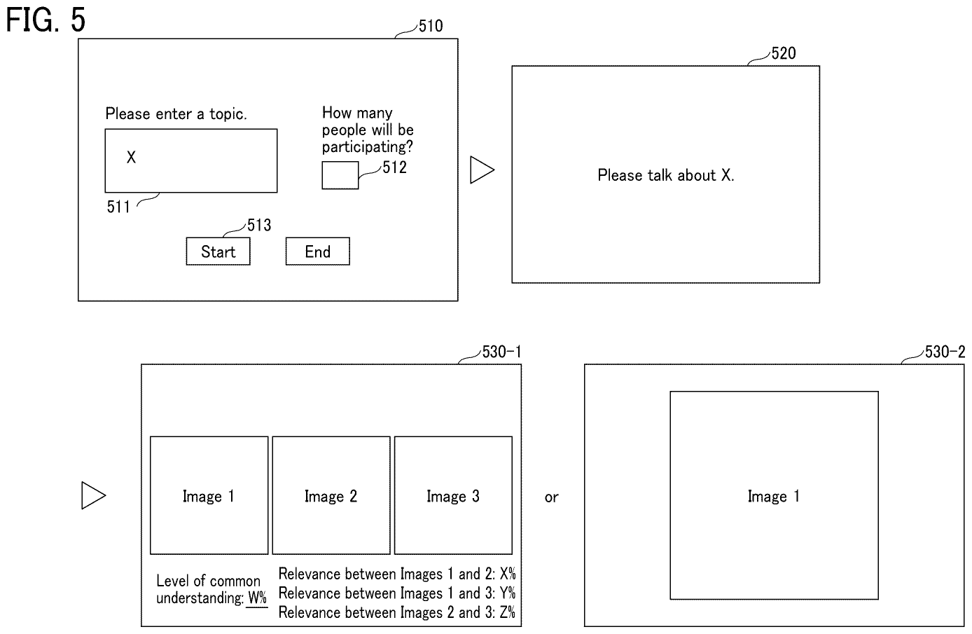

FIG. 5 is a diagram illustrating an example of screens displayed in the first embodiment. In step S101, a screen 510 is displayed on the terminal apparatus 10. The screen 510 may be displayed based on display information received by the terminal apparatus 10 from the server apparatus 40 before the processing of step S101 is executed. The screen 510 includes an input area 511, an input area 512, and a start button 513. The input area 511 is an area for receiving input of an agenda. The input area 512 is an area for receiving input of the number of participants. The start button 513 is a button for receiving a request to start a meeting.

An agenda is input to the input area 511, the number of participants is input to the input area 512, and the start button 513 is pressed. Then, in step S102, the input data transmission unit 12 transmits meeting information including the input agenda and the number of participants to the server apparatus 40. An input image may be input via the screen 510. For example, a file that stores an input image may be selected via the screen 510, and the input image stored in the file may be transmitted to the server apparatus 40 together with the meeting information.

In response to receiving the meeting information and the like, in step S103, the input data acquisition unit 41 of the server apparatus 40 stores the meeting information and the like in the input data storage unit 451.

Subsequently, in step S104, the display information transmission unit 47 transmits, for example, display information for displaying a meeting start instruction to each terminal apparatus 10. The display control unit 13 of each terminal apparatus 10 displays a screen 520 illustrated in FIG. 5 based on the display information. The screen 520 includes a message indicating an instruction to start a discussion about the agenda. Each participant starts a meeting (hereinafter referred to as a “target meeting”) after referring to the message, and makes an utterance about their understanding and thoughts regarding the agenda. When a single microphone 109b is provided for a plurality of persons in the target meeting, any desired technique may be used to separate speech of each individual participant from utterances made by other participants. In view of ease of separating the speech of each participant who has made an utterance, the meeting may be managed to ensure that participants speak one by one. When the microphone 109b is provided for each participant in the target meeting (including an online meeting), a plurality of persons may be allowed to speak at the same time.

The meeting may be started without execution of the processing of steps S101 to S104.

In step S105, the input unit 11 of the terminal apparatus 10 receives input of audio data from the microphone 109b during the target meeting. In step S106, the input data transmission unit 12 transmits the audio data to the server apparatus 40. In step S107, the input data acquisition unit 41 of the server apparatus 40 stores the received audio data in the input data storage unit 451. The processing of steps S105 to S107 is repeatedly executed until the target meeting ends. Accordingly, audio data up to the end of the target meeting is stored in the input data storage unit 451. When a single microphone 109b is provided for a plurality of participants, audio data of the participants is stored as a single piece of data. On the other hand, when the microphone 109b is provided for each participant in the target meeting (including an online meeting), respective audio data of the participants is stored. In this case, the input data acquisition unit 41 may store audio data of each participant, which is obtained from the terminal apparatus 10 or the microphone 109b associated with the participant, in the input data storage unit 451 in association with identification information of the participant. Identification information of each participant may be referred to as “participant identification information” in the following description. A correspondence relationship between each terminal apparatus 10 or each microphone 109b and participant identification information is set in advance.

The duration of the target meeting may be set in advance in the server apparatus 40, or may depend on when the power to the microphone 109b or the terminal apparatus 10 is turned off.

In response to an end of the meeting, in step S108, the text generation unit 42 performs, for example, transcription or text shaping on the audio data by using natural language processing to generate text data. At this time, if audio data is distinguished for each of the participants, the text generation unit 42 generates text data for the audio data to generate respective text data of the participants. If audio data is not distinguished for each of the participants, the text generation unit 42 further performs speaker separation on the audio data to generate respective text data of the participants. At this time, speaker separation may be performed using the number of participants included in the meeting information. Text shaping includes, for example, inserting punctuation marks, deleting unnecessary text data, and deleting spaces.

Subsequently, in step S109, the emotion analysis unit 43 generates emotion data for each participant, based on text data indicating the content of an utterance made by the participant and the emotion model m1. Specifically, the emotion analysis unit 43 inputs, for each participant, text data indicating the content of an utterance made by the participant to the emotion model m1, and acquires emotion data output from the emotion model m1. The emotion analysis unit 43 may generate an overall emotion of all the participants. In this case, the emotion analysis unit 43 may input a set of respective text data of all the participants to the emotion model m1, and may acquire emotion data output from the emotion model m1 as overall emotion data.

Subsequently, in step S110, the image generation unit 44 generates a prompt to be input to the image generation model m2, based on the agenda and the respective text data of the participants. At this time, the image generation unit 44 generates prompts for the respective text data (hereinafter referred to as “corresponding prompts”) and a prompt based on a set of the respective text data (hereinafter referred to as an “integrated corresponding prompt”). A corresponding prompt based on certain text data is text data for causing the image generation model m2 to generate a corresponding image based on the agenda and the text data. The integrated corresponding prompt is text data for causing the image generation model m2 to generate an integrated corresponding image based on the agenda and utterances made by all the participants. Regardless of whether a corresponding prompt or an integrated corresponding prompt is to be generated, the image generation unit 44 may perform, for example, morphological analysis or keyword extraction on source text data to generate a prompt using words with relatively high weight (hereinafter referred to as “keywords”) and the audio data. When the image generation model m2 to be used supports prompts in a specific language (e.g., English), the image generation unit 44 may perform language conversion (i.e., translation) on each prompt to convert the prompt into a language supported by the image generation model m2. The image generation unit 44 may perform, based on the weights of keywords obtained by keyword extraction, weighting for each keyword in the prompt. The weighting increases the influence of the keywords on generated image data.

For example, the agenda and the keywords are combined as follows to generate a prompt.
“<agenda> inspired by (‘work’: 2.692), (‘companion’: 1.923), (‘new’: 1.538), (‘future’: 1.538), (‘ai’: 1.154), (‘robot’: 1.154)”
The character string “<agenda>” indicates the agenda stored as meeting information. The words “work”, “companion”, “new”, “future”, “ai”, and “robot” are keywords. A numeral paired with each keyword represents a weight of the keyword. The format of the prompt described above conforms to grammar of text that the image generation model m2 is to receive as a prompt. That is, a format including a word and a weight in parentheses is predefined for the image generation model m2. This format differs depending on an image generation model to be used.

The keyword extraction can be performed using any desired technique such as Term Frequency-Inverse Document Frequency (TF-IDF), TextRank, Rapid Automatic Keyword Extraction (RAKE), or analysis using transformers.

Subsequently, in step S111, the image generation unit 44 inputs, for each corresponding prompt, the corresponding prompt to the image generation model m2, and acquires an image (a corresponding image) generated by the image generation model m2 based on the corresponding prompt. Accordingly, a corresponding image is generated for each corresponding prompt (for each participant).

Subsequently, in step S112, the image generation unit 44 inputs the integrated corresponding prompt to the image generation model m2, and acquires an image (an integrated corresponding image) generated by the image generation model m2 based on the integrated corresponding prompt.

The processing of generating a corresponding image for each participant (steps S110 and S111) and the processing of generating an integrated corresponding image (steps S110 and S112) may be executed in parallel for each image.

One of a corresponding image and an integrated corresponding image may be generated. In this case, which image to generate may be set by a user. In the generation of a corresponding image for each participant, a seed value of the image generation model m2 is fixed such that identical image data is generated when identical prompts are input.

When corresponding images are generated, in step S113, the relevance calculation unit 45 calculates, for each corresponding image, relevance to another image. As described above, the term “another image” refers to, for example, another corresponding image, an integrated corresponding image, an input image, or an image generated in advance based on predetermined text data. For example, corresponding images include three images, namely, images 1 to 3, and relevance between corresponding images is calculated. In this case, three relevance values, namely, the relevance between the images 1 and 2, the relevance between the images 1 and 3, and the relevance between the images 2 and 3, are calculated.

For example, a correlation coefficient may be used as relevance. A correlation coefficient may be calculated by various methods such as mean squared error (MSE), structural similarity index (SSIM), histogram comparison, feature vector comparison using a neural network, and comparison of objects detected in an image. Any of such methods may be used, or a value obtained by combining results calculated by a plurality of methods as a linear sum may be employed.

The relevance values may be normalized within a range of 0 to 100 in consideration of ease of understanding for a user. In this case, a larger value indicates higher correlation (i.e., stronger association).

The relevance calculation unit 45 calculates the average of the relevance values as a level of common understanding. The level of common understanding is a measure of the degree of common understanding of the agenda by the participants.

In a case where corresponding images are not generated, that is, in a case where an integrated corresponding image is generated, the processing of step S113 may be omitted.

Subsequently, in step S114, the display information generation unit 46 generates display information (e.g., a screen) for displaying the generated image or images (corresponding images or an integrated corresponding image, or corresponding images and an integrated corresponding image) in association with the emotion data. At this time, in a case where relevance is generated for each corresponding image, the display information generation unit 46 generates display information such that the relevance is displayed in association with each corresponding image and the level of common understanding is displayed. When a correspondence relationship between each corresponding image and a respective one of the participants (participant identification information) is identified, the display information generation unit 46 may generate display information such that the participant identification information is further displayed in association with each corresponding image. Further, the display information generation unit 46 processes a generated image (corresponding images or an integrated corresponding image, or corresponding images and an integrated corresponding image), based on an emotion indicated by the emotion data generated for a participant corresponding to the image (the emotion having the highest probability in the emotion data).

Subsequently, in step S115, the display information transmission unit 47 transmits the generated display information to each terminal apparatus 10. In response to receiving the display information, in step S116, the display control unit 13 of each terminal apparatus 10 displays, based on the display information, a screen 530-1 or 530-2 illustrated in FIG. 5 based on the display information. In the following description, the screen 530-1 or 530-2 may be referred to as a “screen 530” unless distinguished. The screen 530 may be displayed on the display 106a, or may be displayed by a projector connected to the terminal apparatus 10.

The screen 530-1 is an example screen displayed when the number of participants of the target meeting is three and corresponding images are generated for respective participants. The screen 530-1 includes the corresponding images, and further includes, as display elements, the relevance between the corresponding images (i.e., the relevance between each of the three pairs of the two corresponding images) and the level of common understanding. In a case where a correspondence relationship between each corresponding image and a respective one of the participants can be identified, participant identification information may be displayed in association with each corresponding image.

The screen 530-2 is an example screen displayed when a single integrated corresponding image is generated for all the participants.

In a case where both corresponding images and an integrated corresponding image are generated, a screen including the screens 530-1 and 530-2 may be displayed.

A specific example of a screen 530 for displaying corresponding images or an integrated corresponding image generated when three persons conduct a meeting with an agenda regarding “the office of the future” will now be described.

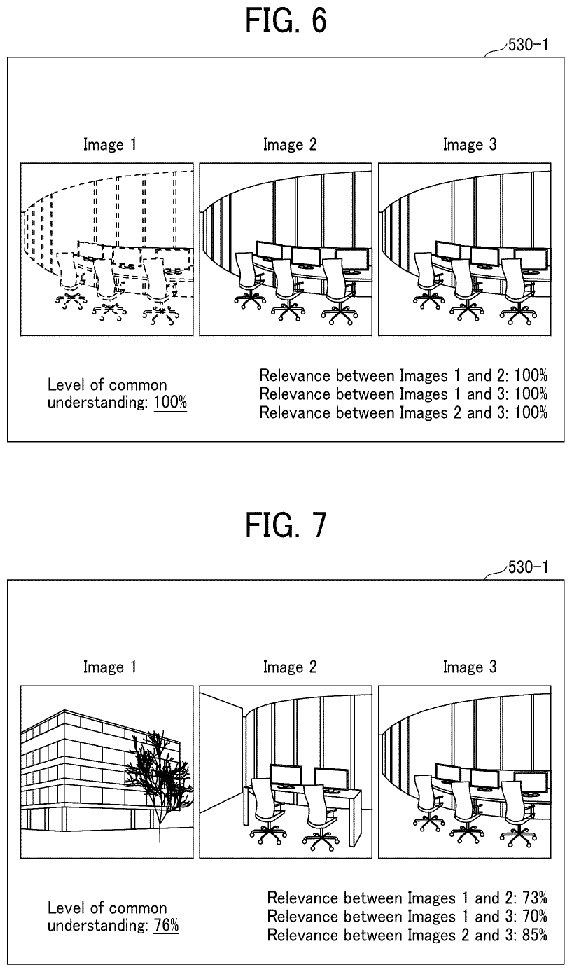

FIG. 6 is a diagram illustrating a first specific example of the screen 530. A screen 530-1 illustrated in FIG. 6 has a configuration similar to that of the screen 530-1 illustrated in FIG. 5. FIG. 6 illustrates, as an example, display of the screen 530-1 in a case where three persons have made utterances of completely the same content. In this case, the three corresponding images have the same content, and the relevances between corresponding images are all 100%. The level of common understanding, which is the average relevance, is 100%. However, the corresponding images are processed in a manner corresponding to emotions indicated by emotion data of the respective participants associated with the corresponding images. For example, an emotion of a participant corresponding to image 1 is “anxiety”. Thus, the image 1 is corrected into a blurred image. Also, image 2 and image 3 are adjusted to have color tones corresponding to respective corresponding emotions. For example, when an emotion of a participant corresponding to the image 2 is “joy”, the image 2 is adjusted to have warm color tones. For example, when an emotion of a participant corresponding to the image 3 is “calmness”, the image 3 is adjusted to have cool color tones.

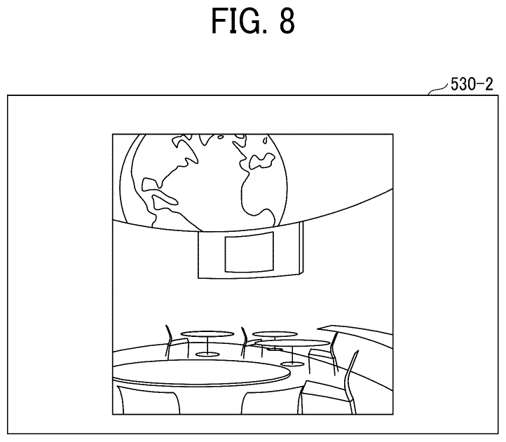

FIG. 7 is a diagram illustrating a second specific example of the screen 530. As in FIG. 6, a screen 530-1 illustrated in FIG. 7 also has a configuration similar to that of the screen 530-1 illustrated in FIG. 5. However, FIG. 7 illustrates, as an example, display of the screen 530-1 in a case where three persons have made utterances of different contents. In this case, the three corresponding images have different contents depending on the utterances made by the respective participants. Accordingly, the relevance between corresponding images is not 100%, and the level of common understanding is 76%. In the present example, a normalized value of a linear sum of a correlation coefficient of feature vectors and a correlation coefficient obtained by converting a grayscale image into one dimension is used as the level of common understanding.

In FIG. 7, image 2 (center) and image 3 (right) are corresponding images based on utterances having similar contents, as indicated by the contents and the relevance (85%) of the corresponding images. Further, image 1 (left) appears to be different in content from the images 2 and 3, but the images 1, 2, and 3 share common points in luminance patterns when converted to grayscale. This indicates that, regarding the “office of the future”, the directions of understanding are divided into two: a panoramic view (the exterior of the office) and a subjective view (the interior of the office). This insight can be useful for subsequent discussions. Also in FIG. 7, the corresponding images are processed in a manner corresponding to emotions indicated by emotion data of the respective participants associated with the corresponding images.

FIG. 8 is a diagram illustrating a third specific example of the screen 530. A screen 530-2 illustrated in FIG. 8 has a configuration similar to that of the screen 530-2 illustrated in FIG. 5. That is, the screen 530-2 illustrated in FIG. 8 includes a single image that is an integrated corresponding image based on the content of utterances made by three persons. Since the image is generated based on a combination of utterances from the three persons, such visualized information can activate or deepen discussions through feedback such as “This part is different from what I imagined!” or “I can relate to this part!”. When overall emotion data is generated, the integrated corresponding image may be processed in a manner corresponding to an emotion indicated by the overall emotion data.

Participants who view the screen 530 as illustrated in FIG. 6 to FIG. 8 can quantitatively grasp the level of common understanding as a numerical value (see FIG. 6 or FIG. 7), and can share the directions of understanding based on the respective viewpoints in a visible form as an image.

In a modification of the present embodiment, corresponding images may be displayed without displaying the level of common understanding as a numerical value. Even in this case, visual comparison between a corresponding image based on the content of an utterance made by a participant and a corresponding image related to the content of an utterance made by another participant or an integrated corresponding image allows the participant to visually recognize a difference between an impression of the utterance made by the participant and an impression of the utterance made by the other participant or an impression of utterances as a whole.

As described above, according to the first embodiment, an image such as corresponding images or an integrated image is generated using text data indicating the content of utterances made by respective participants in a meeting and the image generation model m2, and is displayed. That is, an image is dynamically generated in accordance with the content of the utterances. Each image is processed based on an emotion of a respective associated one of the participants. Thus, visualization can be performed based on respective unique information of participants of a gathering such as a meeting. For example, qualitative events included in utterances made in a gathering such as a meeting can be visualized. The qualitative events refer to qualitative, invisible, ambiguous events, and include, for example, thoughts, emotions, or mental states of a person included in an utterance.

A second embodiment will be described. In the second embodiment, differences from the first embodiment will be described. Accordingly, the second embodiment may be similar to the first embodiment unless otherwise specified. Functions and configurations described in the second embodiment may be combined with the functions and configurations described in the first embodiment.

The second embodiment illustrates an example in which the information processing system 1 operates in collaboration with an online conference system, such as Zoom® or Teams®, to generate a prompt based on text data of each speaker for each predetermined time segment generated by a transcription function provided by the online conference system, and generates a corresponding image for each speaker. In the following description, such an online conference system may be referred to as a “collaborative conference system”).

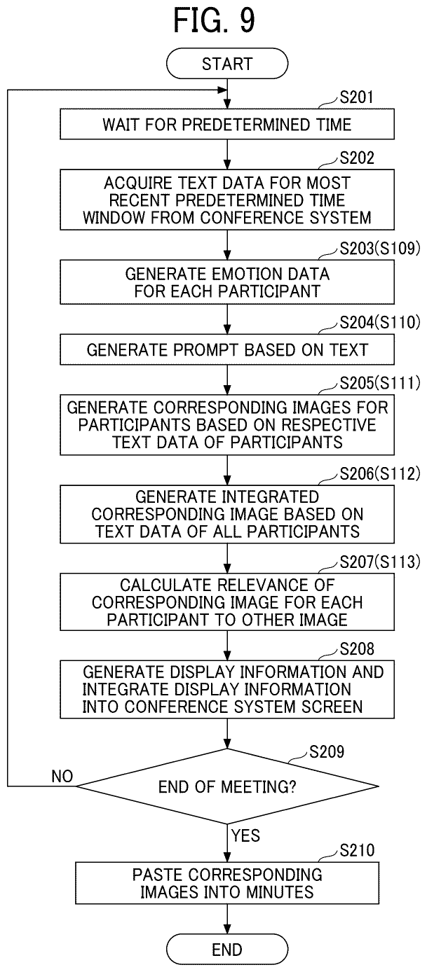

FIG. 9 is a flowchart illustrating an example of a processing procedure executed by the information processing system 1 according to the second embodiment. In FIG. 9, steps that are the same as or correspond to those of FIG. 4 are designated by the same step numbers as those of FIG. 4 in parentheses.

In step S201, the input data acquisition unit 41 waits for a predetermined time (e.g., 20 seconds). The terminal apparatus 10 of each participant of an online meeting displays a collaborative conference system screen.

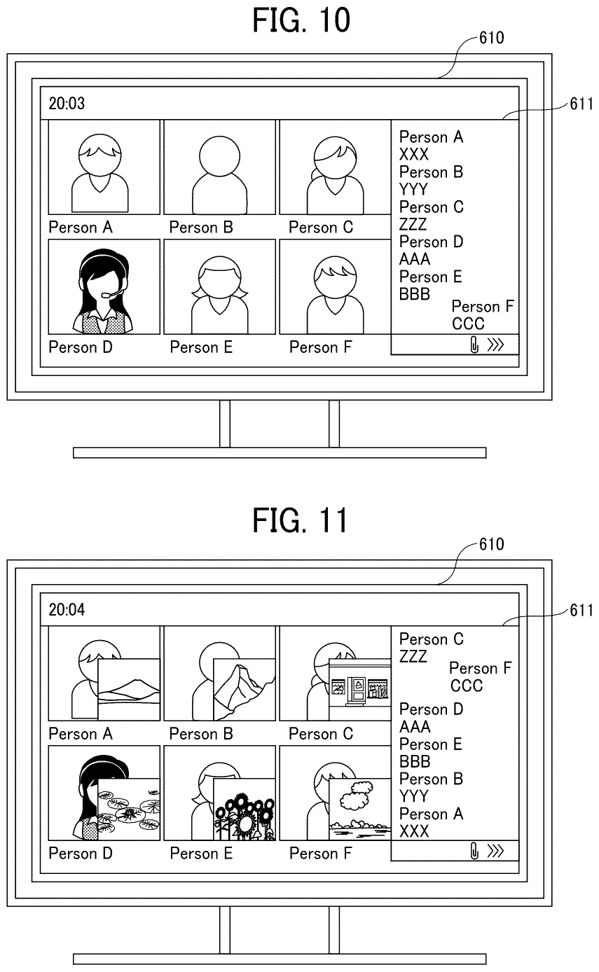

FIG. 10 is a diagram illustrating an example of a collaborative conference system screen. In FIG. 10, a screen 610 is an example of a collaborative conference system screen. The screen 610 includes windows each displaying video of a respective one of the participants of the online meeting and a text area 611 including texts of utterances made by the respective participants in time series. The texts are obtained via transcription of the utterances.

When the predetermined time elapses, in step S202, the input data acquisition unit 41 acquires, from the collaborative conference system, text data generated for each participant of the online meeting during a most recent predetermined time segment, in association with participant identification information of the participant who has made the speech corresponding to the text data. The acquired text data corresponds to character strings generated by dividing text data obtained from start to end of the online meeting into chronological segments.

Subsequently in steps S203 to S207, processing similar to that of steps S109 to S113 of FIG. 4 is performed for each item of acquired text data. As a result, an integrated corresponding image over the most recent predetermined period of time and the respective corresponding images for the participants of the online meeting are generated. Either one or both of steps S205 and S206 may be omitted. That is, the generation of an integrated corresponding image may be omitted. Furthermore, the calculation of the relevance may be omitted.

Subsequently, in step S208, the display information generation unit 46 integrates the corresponding images into the screen 610 serving as a collaborative conference system screen.

FIG. 11 is a diagram illustrating a first display example of a collaborative conference system screen including corresponding images.

In a screen 610 illustrated in FIG. 11, a window for each participant is overlaid with a corresponding image that is associated with a respective one of the participants and is processed based on an emotion of the respective one of the participants. Each window includes participant identification information of a respective one of the participants. Thus, the screen 610 displays a corresponding image and participant identification information in association with each other.

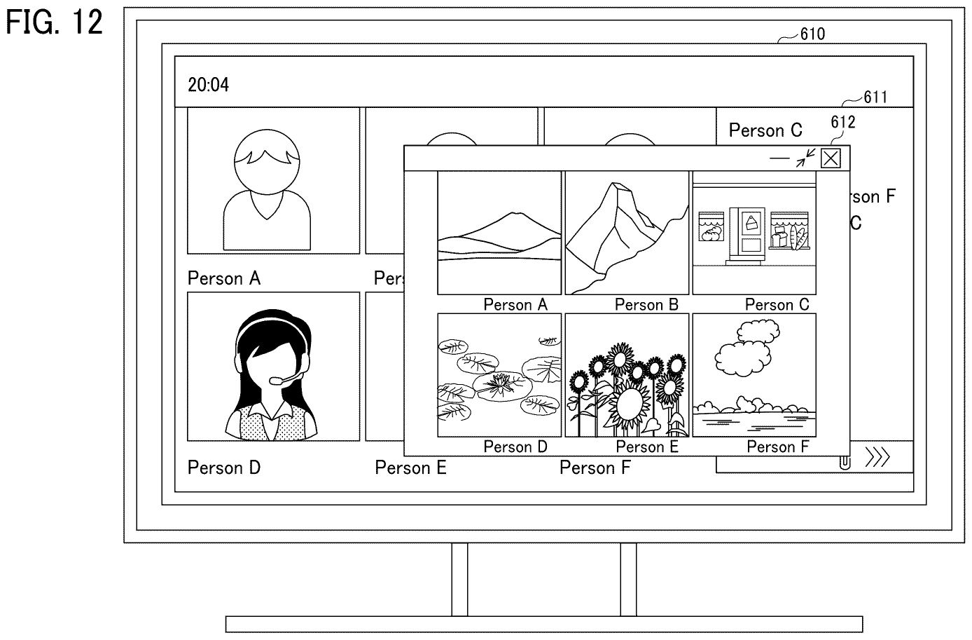

FIG. 12 is a diagram illustrating a second display example of a collaborative conference system screen including corresponding images. A screen 610 illustrated in FIG. 12 is overlaid with a popup screen 612 including corresponding images and participant identification information of respective participants in association with each other. Each corresponding image is processed based on an emotion of a respective associated one of the participants.

In a case where an integrated corresponding image is generated or in a case where relevance is generated, the integrated corresponding image or the relevance may also be displayed in FIG. 11 or FIG. 12. The relevance may be displayed such that a correspondence relationship between the relevance and a corresponding image associated with the relevance can be identified.

The processing of steps S201 to S208 is repeatedly performed until the online meeting ends. Thus, each participant can conduct a discussion while checking corresponding images of respective participants at regular intervals as the meeting progresses. As a result, it is possible to expect, for example, activation of discussions and creation of new ideas.

When the online meeting ends (Yes in step S209), then in step S210, the display information generation unit 46 adds (pastes) thumbnails of corresponding images to minutes data generated by a minutes system of the collaborative conference system. The minutes data includes, in time series, text data indicating the content of utterances made by respective participants (i.e., character strings obtained by dividing the whole text data of the meeting into chronological segments) and participant identification information of the participants associated with the text data in association with each other in time series. Each of the thumbnails is added (pasted) to the minutes data at a position corresponding to a timing at which each repeatedly generated corresponding image is generated, and each thumbnail is a thumbnail of a corresponding image generated at the timing and processed based on the emotion of the participant associated with the corresponding image at the timing. The minutes data is an example of display information including character strings generated by dividing text data obtained from start to end of the online meeting into chronological segments. The display information generation unit 46 may generate the minutes data without using the minutes system, based on the text data acquired in step S202.

The minutes data is transmitted to the terminal apparatus 10 in response to a predetermined operation on the terminal apparatus 10, and the display control unit 13 of the terminal apparatus 10 controls display of the minutes data.

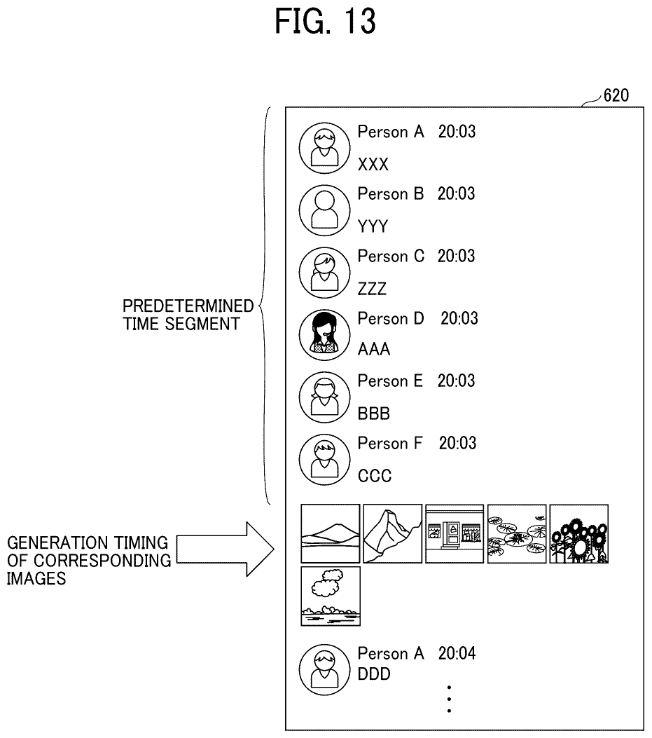

FIG. 13 is a diagram illustrating a display example of minutes data. As illustrated in FIG. 13, minutes data 620 includes, for each predetermined time segment, text data (character strings that are chronological segments) corresponding to utterances made in the time segment in time-series order. The minutes data 620 includes, at a position corresponding to an end of a time segment (i.e., a timing at which corresponding images are generated), thumbnails of corresponding images for the respective participants. The thumbnails of the corresponding images are based on text data and emotion data corresponding to the utterances made by the respective participants in the time segment. Each thumbnail may be clicked to display the associated corresponding image in an enlarged manner or save the associated corresponding image.

The minutes data 620 described above allows visual review of the meeting, and can be used as a memory trigger.

Also in the first embodiment, corresponding images and an integrated corresponding image may be generated at regular intervals, and displayed. A user may set whether to generate corresponding images at regular intervals. That is, a portion of text data from start to end of a meeting that the image generation unit 44 uses to generate corresponding images may be changeable based on designation of a “start” position or an “end” position by a user, or based on predetermined conditions set in the system.

In a case where corresponding images are generated at regular intervals, a message that prompts a user to review an agenda may be output when the relevance or the level of common understanding is continuously kept low.

A third embodiment will be described. In the third embodiment, differences from the first embodiment will be described. Accordingly, the third embodiment may be similar to the first embodiment unless otherwise specified. Functions and configurations described in the third embodiment may be combined with the functions and configurations described in the first embodiment.

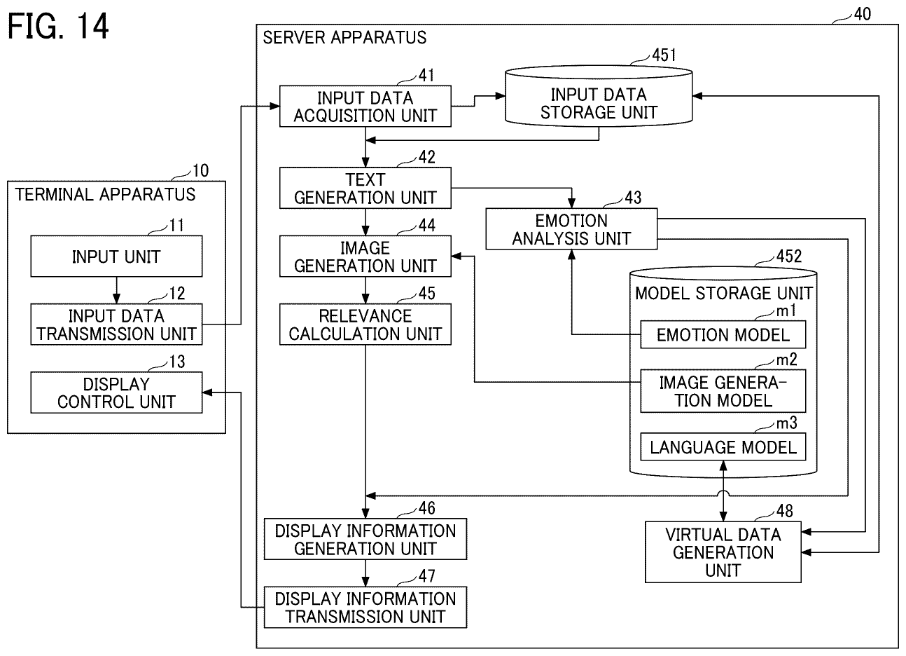

FIG. 14 is a diagram illustrating an example functional configuration of the information processing system 1 according to the third embodiment. In FIG. 14, substantially the same components as those of FIG. 3 are designated by identical or similar reference signs, and descriptions thereof are omitted.

In FIG. 14, the server apparatus 40 further includes a virtual data generation unit 48. The model storage unit 452 further stores a language model m3. The virtual data generation unit 48 is implemented by processing executed by the CPU 401 in accordance with one or more programs installed in the server apparatus 40.

The language model m3 is a machine learning model that receives text as input and outputs, in a text format, sentences having content corresponding to the text. For example, an existing large language model (LLM) may be used as the language model m3.

Like a chatbot, the virtual data generation unit 48 acts as a virtual participant, and makes virtual (pseudo) utterances in the target meeting. The virtual data generation unit 48 generates unique data (text data indicating utterance content) indicating virtual unique information (text indicating utterance content) of a virtual participant at, for example, timings (hereinafter referred to as “virtual utterance timings”) occurring at regular intervals (hereinafter referred to as “virtual utterance intervals”) during the target meeting, based on the unique data (text data indicating the content of utterances) and emotion data of other participants. The virtual data generation unit 48 generates the unique data using the language model m3.

For example, each time a virtual utterance timing arrives, the virtual data generation unit 48 performs processing similar to that of step S108 on each item of audio data stored in the input data storage unit 451 in step S107, which is performed during the immediately preceding virtual utterance interval (the entire time segment of the virtual utterance interval or the last 1- to 3-minute time segment thereof), to generate text data. The emotion analysis unit 43 generates emotion data for each participant, based on the text data and the emotion model m1. At this time, in a case where specific emotion data (emotion data indicating anger) is not generated, the virtual data generation unit 48 inputs a prompt to the language model m3, including the text data and the instruction, “As a meeting participant, speak based on the agenda and the content of utterances made by other participants”. On the other hand, in a case where specific emotion data (emotion data indicating anger) is generated, the virtual data generation unit 48 inputs a prompt to the language model m3, including the text data and the instruction, “As a meeting participant, speak based on the agenda, the content of utterances made by other participants, and {emotion} so as to suppress {emotion} (to, for example, regain calmness)”. The placeholder {emotion} is replaced with an emotion indicated by the specific emotion data. By inputting such a prompt, suppression of emotions that hinder the progress of the meeting, such as anger, can be expected. The virtual data generation unit 48 generates audio data of an utterance corresponding to text data generated by the language model m3 based on the prompt, causes each terminal apparatus 10 to output the audio data, and stores the text data in the input data storage unit 451 in association with identification information of the virtual participant. Audio data of an utterance corresponding to text data may be generated using any desired speech synthesis technique.

In the third embodiment, in and after step S109, the text data (utterance) related to the virtual participant is also handled in the same manner as other participants. That is, in steps S109 and S110, emotion data and a corresponding prompt are generated also for the text data related to the virtual participant, and a corresponding image is generated based on the corresponding prompt. Each corresponding image and the integrated corresponding image are processed based on respective corresponding emotion data. At this time, emotion data may be generated also for the virtual participant. The subsequent processing may be similar to that in the first embodiment.

The virtual utterance timings may not necessarily occur at regular intervals. For example, the virtual utterance timings may be timings at which the frequency of utterances in the target meeting decreases (e.g., when the number of utterances during a most recent predetermined period is equal to or less than a threshold).

As described above, according to the third embodiment, by adding a virtual participant, discussions in the target meeting can be expected to become active.

A fourth embodiment will be described. In the fourth embodiment, differences from the first embodiment will be described. Accordingly, the fourth embodiment may be similar to the first embodiment unless otherwise specified. Functions and configurations described in the fourth embodiment may be combined with the functions and configurations described in the first embodiment.

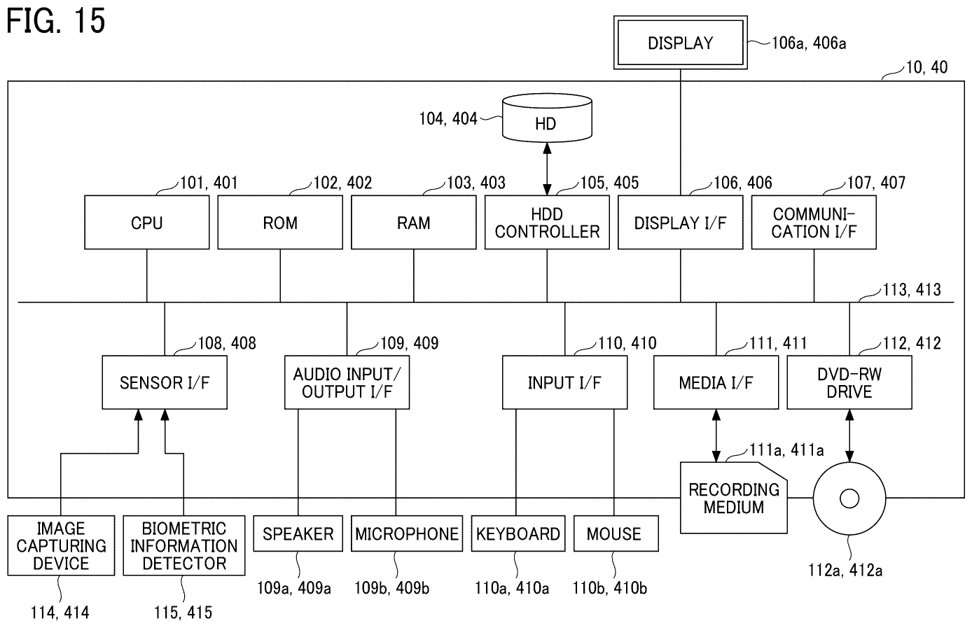

FIG. 15 is a diagram illustrating an example hardware configuration of the terminal apparatus 10 according to the fourth embodiment. In FIG. 15, the terminal apparatus 10 is further connected to an image capturing device 114 and a biometric information detector 115.

The image capturing device 114 is a camera that captures an image including, for example, the face or a posture of a user of the terminal apparatus 10. The user is a participant of the target meeting. An image captured by the image capturing device 114 may be a moving image, or may be a still image captured at certain time intervals.

The biometric information detector 115 is a sensor or the like that measures biometric information of the user of the terminal apparatus 10, which is a participant of the target meeting. Examples of the biometric information include blood pressure and pulse rate.

In the fourth embodiment, the unique data includes first-type unique data and second-type unique data. The first-type unique data includes first-type unique information, and the second-type unique data includes second-type unique information. The first-type unique information refers to text indicating at least either characters input by a participant during the meeting or utterance content of the participant during the meeting. The second-type unique information refers to unique information based on a reaction of any other participant to first-type unique information. The second-type unique information includes at least one of operation information indicating an operation input by a participant who has reacted to first-type unique information of any other participant, captured image information of the participant, which is captured by the image capturing device 114, and biometric information of the participant, which is detected by the biometric information detector 115. Examples of the operation information include input characters. The captured image information may or may not be displayed on a display unit.

The image capturing device 114 and the biometric information detector 115 are used to detect reactions to, for example, utterances made by other participants.

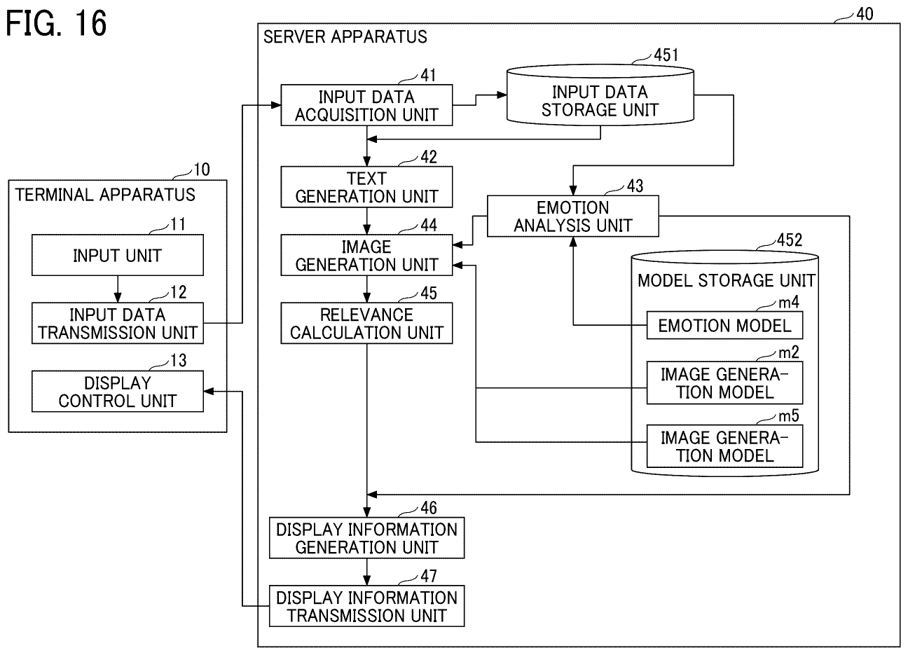

FIG. 16 is a diagram illustrating an example functional configuration of the information processing system 1 according to the fourth embodiment. In FIG. 16, substantially the same components as those of FIG. 3 are designated by identical or similar reference signs, and descriptions thereof are omitted.

In FIG. 16, the model storage unit 452 further stores an image generation model m5. The image generation model m5 is a machine learning model that receives, as inputs, first-type unique data of a first participant and (an emotion indicated by) emotion data based on second-type unique data of a second participant and outputs a corresponding image corresponding to the first-type unique data and the second-type unique data. Specifically, the corresponding image output from the image generation model m5 is a corresponding image related to a reaction to an utterance made by another participant. Thus, the corresponding image captures how the second participant reacts to an utterance made by the first participant.

Specifically, the image generation model m5 is trained using training data including an emotion indicated by emotion data as input data, and a ground-truth image. The emotion data is based on text of an utterance made by another participant and information of a participant who has reacted to the other participant, including operation information, captured image information, and biometric information. In the following description, the participant who has reacted to the other participant may be referred to as a “participant R”, and the operation information, captured image information, and biometric information of the participant R may be referred to as “reaction information”. The operation information of the participant R indicates an operation on the terminal apparatus 10. The captured image information indicates an image of, for example, the face or posture of the participant R. Examples of the biometric information include blood pressure and pulse rate.

That is, the image generation model m5 is trained such that an image output by the image generation model m5 when the input data included in the training data is input approaches the ground-truth image included in the training data. When the emotion data included in the training data as the input data indicates a positive reaction to an utterance made by another participant, the ground-truth image in the training data is an image having relatively high relevance to a corresponding image generated by the image generation model m2 for the utterance made by the other participant. On the other hand, when the emotion data included in the training data as the input data indicates a negative reaction to an utterance made by another participant, the ground-truth image in the training data is an image having relatively low relevance to a corresponding image generated by the image generation model m2 for the utterance made by the other participant.

Thus, when input emotion data, which is based on the reaction information of the participant R, indicates a positive emotion for an utterance made by another participant, the image generation model m5 generates a corresponding image having relatively high relevance to a corresponding image associated with input text of the utterance made by the other participant. When input emotion data, which is based on the reaction information of the participant R, indicates a negative emotion for an utterance made by another participant, the image generation model m5 generates a corresponding image having relatively low relevance to a corresponding image associated with input text of the utterance made by the other participant.

In FIG. 16, the emotion analysis unit 43 uses an emotion model m4 instead of the emotion model m1. The emotion model m4 is a machine learning model that receives reaction information as input and generates emotion data. The emotion model m4 is trained using training data including, for example, reaction information and an emotion. The training data includes, for example, reaction information for training as input and a ground-truth emotion for output. The emotion model m4 is trained such that, for example, emotion data generated by the emotion model m4 when reaction information included in the training data is input maximizes the probability of a ground-truth emotion included in the training data.

A processing procedure according to the fourth embodiment will be described with reference to FIG. 4. The input data transmission unit 12 of each terminal apparatus 10 transmits reaction information of the user of the terminal apparatus 10 to the server apparatus 40 in response to an utterance made by a participant who is a user of another terminal apparatus 10. The input data acquisition unit 41 of the server apparatus 40 stores the received reaction information in the input data storage unit 451 for each participant. Thus, for audio data of an utterance made by each participant, reaction information of other participants is stored in the input data storage unit 451 during a period of time until the target meeting ends.

In step S109, the emotion analysis unit 43 generates emotion data of each participant, based on reaction information stored in the input data storage unit 451 for each participant and the emotion model m4.

In step S111, the image generation unit 44 further inputs emotion data of each participant, which is generated based on reaction information of the participant to each of the other participants, and text data of an utterance made by each of the other participants to the image generation model m5, and acquires an image output by the image generation model m5 as a corresponding image related to a reaction of the participant.

For example, in response to an utterance made by person A, person B smiles. That is, the person B expresses a positive reaction. In this case, the person B agrees with the utterance made by the person A. That is, the person B feels positive about the utterance made by the person A. Thus, a corresponding image having high relevance, or high pertinence, to a corresponding image associated with the utterance made by the person A is generated for the person B.

On the other hand, in response to an utterance made by person A, person B exhibits a dissatisfied expression. That is, the person B expresses a negative reaction. In this case, the person B does not agree with the utterance made by the person A. That is, the person B feels negative about the utterance made by the person A. Thus, a corresponding image having low relevance to a corresponding image associated with the utterance made by the person A is generated for the person B.

While an example has been described in which a facial expression is used as reaction information, a corresponding image may also be generated in a way similar to that for a facial expression by labeling a positive reaction and a negative reaction for information on a participant, such as a posture and a pulse rate, and training the image generation model m5 using the labeled reactions.

Other processing may be similar to that in the first embodiment.

Consequently, in the fourth embodiment, corresponding images related to reactions to utterances made by other participants are also displayed.

The fourth embodiment may be combined with the embodiments described above.

As described above, according to the fourth embodiment, a reaction of another participant to an utterance made by a certain participant can also be represented using an image.

A fifth embodiment will be described. In the fifth embodiment, differences from the third embodiment will be described. Accordingly, the fifth embodiment may be similar to the third embodiment unless otherwise specified. Functions and configurations described in the fifth embodiment may be combined with the functions and configurations described in the third embodiment.

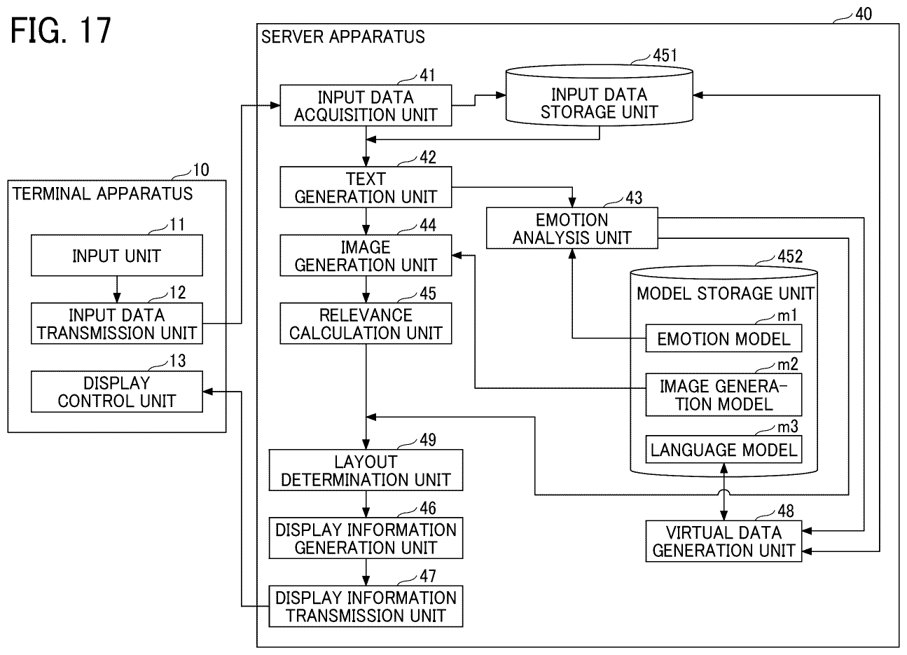

FIG. 17 is a diagram illustrating an example functional configuration of the information processing system 1 according to the fifth embodiment. In FIG. 17, substantially the same components as those of FIG. 14 are designated by identical or similar reference signs, and descriptions thereof are omitted.

In FIG. 17, the server apparatus 40 further includes a layout determination unit 49. The layout determination unit 49 is implemented by processing executed by the CPU 401 in accordance with one or more programs installed in the server apparatus 40.

The layout determination unit 49 determines at least one of the arrangement of a plurality of corresponding images to be displayed, the size of each corresponding image, and the decoration of each corresponding image, based on the emotion data generated for each participant by the emotion analysis unit 43 and at least one of unique information (i.e., text indicating utterance content and the speech of utterances) and the corresponding images.

Specifically, the layout determination unit 49 determines the arrangement of a plurality of corresponding images to be displayed, based on relevance calculated by the relevance calculation unit 45 between each corresponding image and another image.

The layout determination unit 49 also determines the decoration or size of a corresponding image, based on at least one of emotion data generated for each participant by the emotion analysis unit 43 and items included in the unique information, namely, the amount of utterances made by participants, the volume of the utterances, image information indicating the facial expressions of other participants captured by the image capturing device 114, and changes in biometric information of other participants detected by the biometric information detector 115. In this case, the terminal apparatus 10 has the hardware configuration illustrated in FIG. 15, and reaction information is stored in the input data storage unit 451, as described in the fourth embodiment.

In the fifth embodiment, the display information generation unit 46 generates display information for displaying the corresponding images according to at least one of the arrangement, the size, and the decoration determined by the layout determination unit 49.

Specifically, before the display information generation unit 46 generates display information in step S114 of FIG. 4, the layout determination unit 49 determines arrangement positions or arrangement order of the corresponding images, based on the relevance to another image, which is calculated in step S113 for each of the respective corresponding images associated with the participants including the virtual participant. For example, the layout determination unit 49 determines the arrangement positions of the corresponding images such that a corresponding image having relatively high relevance to a certain image is located relatively closer to the certain image. The certain image may be any one of the corresponding images, an integrated corresponding image, or an agenda image. The agenda image refers to an image generated by the image generation model m2 when text data indicating an agenda is input to the image generation model m2.

Further, the layout determination unit 49 increases the size of each corresponding image or applies decoration such as highlighting to make the corresponding image stand out as the amount of utterances made by a participant associated with the corresponding image increases or as the volume of the utterances increases. Further, the layout determination unit 49 increases the size of each corresponding image or applies decoration such as highlighting to make the corresponding image stand out as a reaction indicated by reaction information to an utterance associated with the corresponding image increases. In other words, the layout determination unit 49 increases the size of each corresponding image or applies decoration such as highlighting to make the corresponding image stand out as an influence on other participants increases.

The amount of utterances made by a participant associated with a certain corresponding image can be evaluated based on the number of characters in text data associated with the corresponding image or text data associated with the participant or the length of audio data corresponding to the text data. The volume of utterances made by a participant associated with a certain corresponding image can be evaluated based on audio data associated with the corresponding image or audio data associated with the participant. For example, the average or maximum value of the volume of the audio data may be set as the volume of an utterance associated with the audio data. The magnitude of a reaction indicated by the reaction information can be evaluated using any desired technique such as OpticalFlow.

The layout determination unit 49 may structure a conversation based on text data of utterances associated with the corresponding images in accordance with the flow of the conversation. Specifically, the layout determination unit 49 may structure the conversation based on the utterance order or by using natural language processing. Based on this structure, the layout determination unit 49 may determine the arrangement of the corresponding images. The structuring refers to, for example, (1) and (2) below.
(1) A chronological structure of a conversation, that is, the utterance order. In this case, the layout determination unit 49 determines a layout based on a time-series flow of utterances associated with the corresponding images.
(2) A network structure of a conversation using a graph based on natural language processing (e.g., a knowledge graph or a co-occurrence network). In the graph, each utterance serves as a node, and related utterances are connected by an edge. In this case, the layout determination unit 49 determines the layout of the corresponding images, based on the degree of relevance between the utterances.

In step S114, the display information generation unit 46 generates display information (e.g., a screen) for displaying the generated images, based on a display mode determined by the layout determination unit 49. Specifically, the display information generation unit 46 generates display information (e.g., a screen) for displaying each corresponding image or an integrated corresponding image or displaying each corresponding image and an integrated corresponding image, based on a display mode determined by the layout determination unit 49.

As a result, in the fifth embodiment, each terminal apparatus 10 displays, for example, the corresponding images in the display mode determined by the layout determination unit 49.

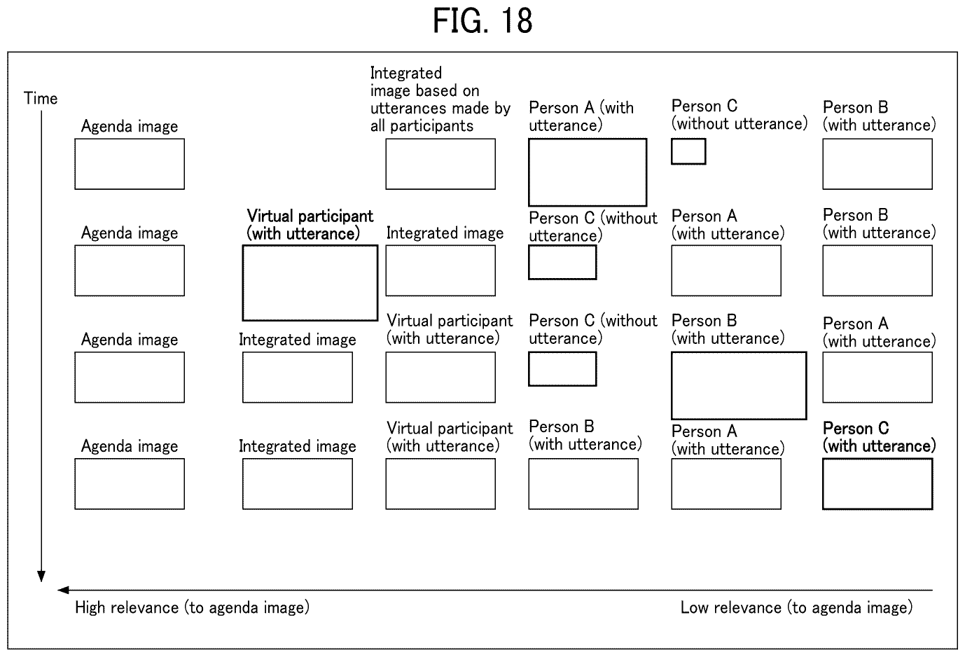

FIG. 18 is a diagram illustrating a display example of corresponding images according to the fifth embodiment. In FIG. 18, the vertical direction corresponds to a time axis that defines the passage of time. The horizontal direction corresponds to the relevance to an agenda image.

In this case, the arrangement position of each corresponding image is determined in time-series order and based on the magnitude of the relevance to an agenda image. The size of each corresponding image is determined by the method described above.

While the first embodiment describes an example in which the processing of step S108 and the subsequent processing are performed in response to the end of the meeting, the processing of step S108 and the subsequent processing may be repeatedly performed at regular intervals during the meeting. In the example illustrated in FIG. 18, corresponding images and integrated corresponding images generated at regular intervals are arranged on the time axis. In the example illustrated in FIG. 18, agenda images are also arranged at regular intervals. The agendas corresponding to the agenda images may be the same or different. In other words, an agenda may be changed during the meeting.

In the example described above, the layout determination unit 49 determines the arrangement position of each corresponding image based on the relevance. Alternatively, the layout determination unit 49 may determine the arrangement positions of the corresponding images and the integrated corresponding images using emotion data generated for the respective corresponding images, namely, emotion data generated for the respective participants associated with the corresponding images.

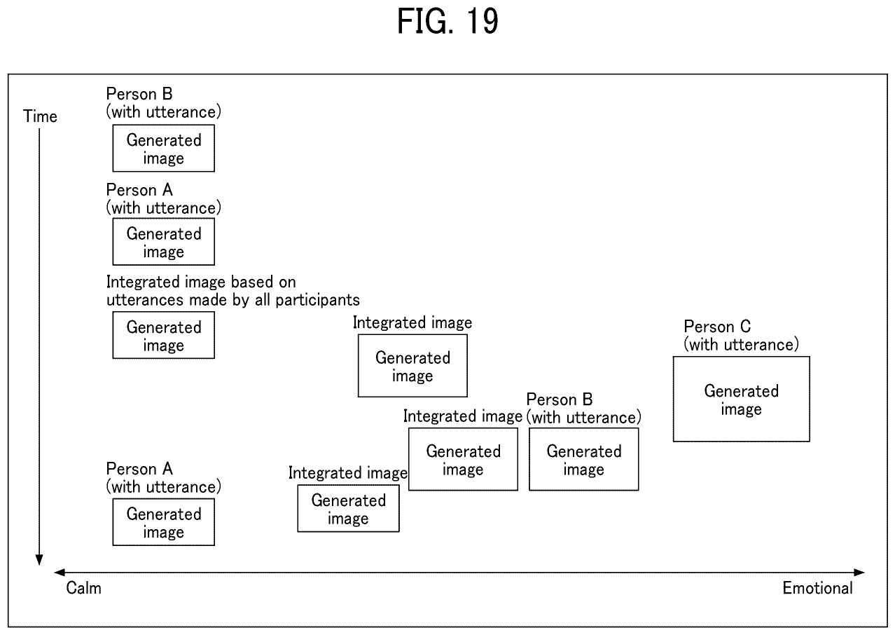

FIG. 19 is a diagram illustrating a second display example of corresponding images according to the fifth embodiment. In FIG. 19, as in FIG. 18, the vertical direction corresponds to a time axis that defines the passage of time. The horizontal direction corresponds to the probability of a specific emotion. In the example illustrated in FIG. 19, a corresponding image is arranged further to the right as the probability of “calmness”, or the degree of calmness, decreases. In other words, a corresponding image associated with a more emotional participant is arranged further to the right.

In this case, the layout determination unit 49 determines the arrangement position of each corresponding image in time-series order and based on the degree of calmness of the participant associated with the corresponding image. The layout determination unit 49 further determines the arrangement position of an integrated corresponding image using the average value of the probabilities of calmness of respective participants as the probability of calmness of the integrated corresponding image. The size of each corresponding image is determined by the method described above. Further, the display information generation unit 46 adjusts the display mode of each image according to emotion data associated with each corresponding image or the integrated corresponding image.

The fifth embodiment may be combined with the embodiments described above. In FIG. 18, a corresponding image marked with the character string “(no utterance)” refers to a corresponding image generated based on reaction information in the fourth embodiment.

As described above, according to the fifth embodiment, a display mode of each corresponding image can be changed according to the degree of influence in a meeting. As a result, the magnitude of influence of each corresponding image can be visually represented.

In the embodiments described above, the display information generation unit 46 may generate display information so as to visually display, in association with each corresponding image, the probability of an emotion indicated by emotion data corresponding to the corresponding image.

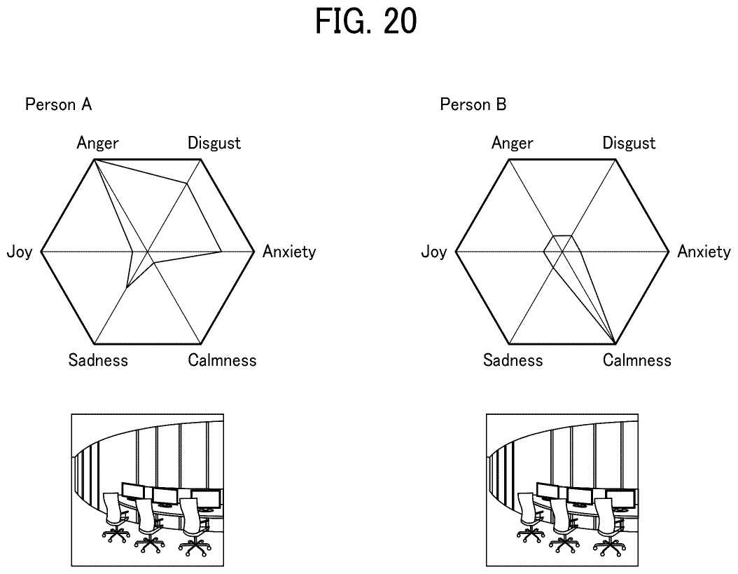

FIG. 20 is a diagram illustrating an example of visual representations of the probabilities of emotions in association with respective corresponding images. In FIG. 20, part (1) illustrates a corresponding image associated with person A and a radar chart indicating emotion data of the person A. In FIG. 20, part (2) illustrates a corresponding image associated with person B and a radar chart indicating emotion data of the person B. Each radar chart visualizes probabilities of types of emotions such as anger, disgust, anxiety, calmness, sadness, and joy. Each corresponding image may be processed based on the emotion data.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described in the above-described embodiments is merely one example of multiple computing environments for implementing the embodiments disclosed herein.

In some embodiments, the server apparatus 40 includes a plurality of computing devices such as a server cluster. The computing devices are configured to communicate with one another through any type of communication link, including a network and a shared memory, and perform the processes disclosed herein.

In the embodiments disclosed herein, the terminal apparatus 10 and the server apparatus 40 are examples of an information processing apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

In a first aspect, an information processing apparatus includes an acquisition unit, an image generation unit, and an emotion analysis unit. The acquisition unit acquires unique data indicating unique information based on behavior of each of a plurality of participants in a gathering. The plurality of participants participate in the gathering. The image generation unit generates, for each of the plurality of participants, a corresponding image associated with the unique data acquired by the acquisition unit, based on the unique data acquired by the acquisition unit and a machine learning model trained using training data. The training data includes unique data indicating the unique information and an image. The emotion analysis unit analyzes an emotion of each of the plurality of participants based on the unique data acquired by the acquisition unit.

According to a second aspect, the information processing apparatus of the first aspect further includes a display information generation unit. The display information generation unit generates display information for displaying the corresponding image based on an analysis result obtained by the emotion analysis unit.

According to a third aspect, the information processing apparatus of the first aspect or the second aspect further includes a virtual data generation unit. The plurality of participants include a virtual participant. The virtual data generation unit generates virtual unique data of the virtual participant, based on the unique data of another participant of the plurality of participants and emotion data analyzed by the emotion analysis unit. The virtual unique data indicates virtual unique information based on behavior of the virtual participant in the gathering. The image generation unit generates, for the virtual participant, a corresponding image associated with the virtual unique data, based on the virtual unique data and the machine learning model.

According to a fourth aspect, in the information processing apparatus of any one of the first to third aspects, the unique data includes first-type unique data including first-type unique information, and second-type unique data including second-type unique information based on a reaction to the first-type unique information. The plurality of participants include a first participant and a second participant. The image generation unit generates, for the second participant, a corresponding image associated with the first-type unique data and emotion data analyzed by the emotion analysis unit, based on the first-type unique data of the first participant, the emotion data, and the machine learning model, the emotion data being based on the second-type unique data of the second participant.

According to a fifth aspect, in the information processing apparatus of the fourth aspect, the first-type unique information includes text indicating at least one of characters input by a participant of the plurality of participants or content of an utterance made by the participant, and the second-type unique information includes at least one of operation information, captured image information of a participant of the plurality of participants, or biometric information of the participant, the operation information indicating an operation input by the participant, the captured image information being captured by an image capturing device, the biometric information being detected by a biometric information detector.

According to a sixth aspect, the information processing apparatus of any one of the first to fifth aspects further includes a display information generation unit. The display information generation unit generates display information for displaying participant identification information for identifying each of the plurality of participants and the corresponding image generated for a corresponding participant of the plurality of participants in association with each other.

According to a seventh aspect, in the information processing apparatus of the sixth aspect, the display information generation unit generates the display information such that emotion data analyzed by the emotion analysis unit is displayed in association with the participant identification information and the corresponding image.

According to an eighth aspect, the information processing apparatus of any one of the first to seventh aspects further includes a layout determination unit and a display information generation unit. The corresponding image includes a plurality of corresponding images. The layout determination unit determines at least one of an arrangement for displaying the plurality of corresponding images, a size of each of the plurality of corresponding images, or a decoration of each of the plurality of corresponding images, based on emotion data analyzed by the emotion analysis unit and at least one of the unique information or the corresponding image. The display information generation unit generates display information for displaying the plurality of corresponding images based on at least one of the arrangement, size, or decoration determined by the layout determination unit.

According to a ninth aspect, in the information processing apparatus of the eighth aspect, the layout determination unit determines a decoration of each of the plurality of corresponding images or a size of each of the plurality of corresponding images, based on at least one of an amount of an utterance made by a participant of the plurality of participants, a volume of the utterance, image information indicating a facial expression of another participant of the plurality of participants, a change in biometric information of said another participant detected by a biometric information detector, or the emotion data. The image information is captured by an image capturing device. The amount of the utterance, the volume of the utterance, the image information, and the change in the biometric information are included in the unique information.

According to a tenth aspect, in the information processing apparatus of the eighth aspect, the image generation unit generates, for each of the plurality of participants, a corresponding image associated with a character string obtained by dividing text data included in the unique data acquired by the acquisition unit into chronological segments, based on the character string and the machine learning model. The display information generation unit generates the display information such that the character string is displayed chronologically in an arrangement corresponding to the emotion data.

In an eleventh aspect, an information processing system includes an acquisition unit, an image generation unit, and an emotion analysis unit. The acquisition unit acquires unique data indicating unique information based on behavior of each of a plurality of participants in a gathering. The plurality of participants participate in the gathering. The image generation unit generates, for each of the plurality of participants, a corresponding image associated with the unique data acquired by the acquisition unit, based on the unique data acquired by the acquisition unit and a machine learning model trained using training data. The training data includes unique data indicating the unique information and an image. The emotion analysis unit analyzes an emotion of each of the plurality of participants based on the unique data acquired by the acquisition unit.

In a twelfth aspect, an information processing method includes causing a computer to execute an acquisition procedure, an image generation procedure, and an emotion analysis procedure. The acquisition procedure acquires unique data indicating unique information based on behavior of each of a plurality of participants in a gathering. The plurality of participants participate in the gathering. The image generation procedure generates, for each of the plurality of participants, a corresponding image associated with the unique data acquired in the acquisition procedure, based on the unique data acquired in the acquisition procedure and a machine learning model trained using training data. The training data includes unique data indicating the unique information and an image. The emotion analysis procedure analyzes an emotion of each of the plurality of participants based on the unique data acquired in the acquisition procedure.

In a thirteenth aspect, a program causes a computer to execute an acquisition procedure, an image generation procedure, and an emotion analysis procedure. The acquisition procedure acquires unique data indicating unique information based on behavior of each of a plurality of participants in a gathering. The plurality of participants participate in the gathering. The image generation procedure generates, for each of the plurality of participants, a corresponding image associated with the unique data acquired in the acquisition procedure, based on the unique data acquired in the acquisition procedure and a machine learning model trained using training data. The training data includes unique data indicating the unique information and an image. The emotion analysis procedure analyzes an emotion of each of the plurality of participants based on the unique data acquired in the acquisition procedure.

1. An information processing apparatus comprising circuitry configured to:
acquire unique data indicating unique information based on behavior of each of a plurality of participants in a gathering, the plurality of participants participating in the gathering;
generate, for each of the plurality of participants, a corresponding image associated with the unique data, based on the unique data and a machine learning model trained using training data, the training data including unique data indicating the unique information and an image; and
analyze an emotion of each of the plurality of participants based on the unique data.

2. The information processing apparatus according to claim 1, wherein
the circuitry is configured to generate display information for displaying the corresponding image based on a result of analysis of the emotion of each of the plurality of participants based on the unique data.

3. The information processing apparatus according to claim 1, wherein
the plurality of participants include a virtual participant, and
the circuitry is configured to:
generate virtual unique data of the virtual participant, based on the unique data of another participant of the plurality of participants and emotion data of the analyzed emotion, the virtual unique data indicating virtual unique information based on behavior of the virtual participant in the gathering; and
generate, for the virtual participant, a corresponding image associated with the virtual unique data, based on the virtual unique data and the machine learning model.

4. The information processing apparatus according to claim 1, wherein
the unique data includes first-type unique data including first-type unique information, and second-type unique data including second-type unique information based on a reaction to the first-type unique information,
the plurality of participants include a first participant and a second participant, and
the circuitry is configured to generate, for the second participant, a corresponding image associated with the first-type unique data and emotion data of the analyzed emotion, based on the first-type unique data of the first participant, the emotion data, and the machine learning model, the emotion data being based on the second-type unique data of the second participant.

5. The information processing apparatus according to claim 4, wherein
the first-type unique information includes text indicating at least one of characters input by the participant or content of an utterance made by the participant, and
the second-type unique information includes at least one of operation information indicating an operation input by the participant, captured image information of the participant being captured by an image capturing device, or biometric information of the participant being detected by a biometric information detector.

6. The information processing apparatus according to claim 1, wherein
the circuitry is configured to generate display information for displaying participant identification information for identifying each of the plurality of participants and the corresponding image generated for a corresponding participant of the plurality of participants in association with each other.

7. The information processing apparatus according to claim 6, wherein
the circuitry is configured to generate the display information such that emotion data of the analyzed emotion is displayed in association with the participant identification information and the corresponding image.

8. The information processing apparatus according to claim 1, wherein
the corresponding image includes a plurality of corresponding images, and
the circuitry is configured to:
determine at least one of an arrangement for displaying the plurality of corresponding images, a size of each of the plurality of corresponding images, or a decoration of each of the plurality of corresponding images, based on emotion data of the analyzed emotion and at least one of the unique information or the corresponding image; and
generate display information for displaying the plurality of corresponding images based on the at least one of the determined arrangement, the determined size, or the determined decoration.

9. The information processing apparatus according to claim 8, wherein
the circuitry is configured to determine a decoration of each of the plurality of corresponding images or a size of each of the plurality of corresponding images, based on at least one of an amount of an utterance made by a participant of the plurality of participants, a volume of the utterance, image information indicating a facial expression of another participant of the plurality of participants, a change in detected biometric information of said another participant, or the emotion data, the image information being captured by an image capturing device,
the amount of the utterance, the volume of the utterance, the image information, and the change in detected biometric information being included in the unique information.

10. The information processing apparatus according to claim 8, wherein the circuitry is configured to:
generate, for each of the plurality of participants, a corresponding image associated with a character string obtained by dividing text data included in the acquired unique data into chronological segments, based on the character string and the machine learning model; and
display the character string chronologically in an arrangement corresponding to the emotion data.

11. An information processing system comprising circuitry configured to:
acquire unique data indicating unique information based on behavior of each of a plurality of participants in a gathering, the plurality of participants participating in the gathering;
generate, for each of the plurality of participants, a corresponding image associated with the unique data, based on the unique data and a machine learning model trained using training data, the training data including unique data indicating the unique information and an image; and
analyze an emotion of each of the plurality of participants based on the unique data.

12. An information processing method comprising:
acquiring unique data indicating unique information based on behavior of each of a plurality of participants in a gathering, the plurality of participants participating in the gathering;
generating, for each of the plurality of participants, a corresponding image associated with the unique data, based on the unique data and a machine learning model trained using training data, the training data including unique data indicating the unique information and an image; and
analyzing an emotion of each of the plurality of participants based on the unique data.
